(19) United States
(12) Patent Application Publication
(10) Pub. No.: US 2003/0183524 A1
(43) Pub. Date: Oct. 2, 2003

(54) Method for decontaminating a region with contaminated heterogeneous soil

(76) Inventors: Valery Vasilievich Lipatov, St. Petersburg (RU); Evgeny Andreevich Ivliev, St Petersburg (RU)

Correspondence Address: John D Gugliotta, Suite 202, 137 South Main Street, Akron, OH, 44308, US

(21) Appl. No.: 10/343,864

(22) PCT Filed: Aug. 7, 2001
(86) PCT No.: PCT/RU01/00333

(51) Int. Cl. C02F 1/469

(52) U.S. Cl. 204/515; 205/766

(57) ABSTRACT

The invention relates to the decontamination of heterogeneous soil with an unbroken structure contaminated with various organic and non-organic pollution agents (heavy metals, petroleum products etc.). The inventive method consists in introducing anode and cathode electrodes into the soil, dividing the region with the contaminated heterogeneous soil into zones in accordance with the soil characteristics and feeding each zone with a corresponding direct-current voltage. Said method decreases the energy cost for decontaminating the soil by taking into account the nature of the pollution agent, the concentration and distribution thereof in the region to be decontaminated.

### FIELD OF THE INVENTION

The invention concern cleaning of non-homogeneous ground polluted by various organic and non-organic pollutants (heavy metals, petroleum products etc). The method envisages in situ cleaning of ground with non-disturbed structure. The field of invention covers various kinds of pollutants and different types of grounds.

### BACKGROUND OF THE INVENTION

The known method of electrochemical cleaning of grounds of pollutants includes: conducting AC current through the ground between the inert anode and the non-reactive cathode, feeding water containing liquid into the ground near the anode, electro-osmotic running of front with low pH through the ground from the anode area in the direction of the said cathode till the said front reaches the cathode area (US,C,5137608).

The disadvantages of this method:

inhomogeneity of ground properties in the area of cleaning and inhomogeneity of pollution is not taken into account which results in excessive power consumption;

pollutants concentrated in the electrode adjacent zones in the from of non-soluble compounds cannot be removed out of the cleaning area.

The known method of electro-osmotic removal of pollutants out of the ground is as follows. One or several porous electrodes-sources and one or several porous electrodes-discharges are inserted in the cleaning area and a voltage gradient is provided between the electrodes: the cleaning liquid is fed to the electrode-source and the voltage gradient causes electro-osmotic movement of the cleaning, liquid through the polluted area towards the electrodes-discharges the cleaning liquid replaces the pollutant and moves through the ground area towards the electrodes-discharges from which it can be removed by pumping (US,C,5074986).

The disadvantages of this method:

the method envisages generation of voltage gradient between electrodes which cannot be implemented under the conditions of undisturbed structure of the ground to be cleaned and the discrete system of electrodes due to non-homogeneous distribution of the gradient of the electric field potential;

the method envisages compulsory application of the cleaning solution and removal of polluted solution, electro-osmotic transfer of pollutants which is not necessary in all cases;

inhomogeneity of ground properties and inhomogeneity of pollution in the cleaning area is not taken into account.

Another method of cleaning the area of polluted non-homogeneous envisages installation of anode and cathode electrodes in the ground division of the area of the polluted non-homogeneous ground into separate zones with similar ground characteristics and feeding DC current of appropriate voltage into each zone, which results in generation of an electro-osmotic flow or electro-migration transfer of pollutants or the both (US,C.5476992).

This method is accepted as the prototype for this invention.

The disadvantage of this method is excessive power consumption, which is explained by the fact that the type of the pollutant, its concentration and its distribution in the ground area to be cleaned is not taken into account.

### DISCLOSURE OF THE INVENTION

This invention is based on solving the problem of reduction of power consumption to the level, which is necessary and sufficient for cleaning the area of non-homogeneous ground under the conditions of various types of pollutants and various concentrations thereof in different zones of this area.

According to the invention this problem is solved by using, the method of cleaning polluted non-homogeneous ground with installation of anode and cathode electrodes at which the area of the polluted non-homogeneous ground is divided into zones with similar ground characteristics and DC current of appropriate voltage is fed into each zone; besides zones are divided by concentration and/or by the type of the pollutant, next volume V₃ of the ground to be cleaned in each zone is determined and electric charge Q₃ is calculated which is required to be conducted through each zone to provide necessary degree of cleaning according to equation Q₃=q₃ V₃, where q₃ —specific charge required to clean a unit of volume of the ground in the zone concerned; electric intensity E≧0.05 V/cm is maintained in each point of the area to be cleaned, the value of electric charge Q₃ is monitored that actually passes through each zone within time period t counting from the start of cleaning according to the formula Q₃=ƒ₀I₍ₜ₎d, where I₍₁₎—the amount of current that passes through the cleaned zone and when Q₃ becomes equal to Q₃ in each zone conducting of current through the appropriate zone is stopped. When cleaning fine porous ground value q₃ is determined from the equation:

$${q}_{3} = \frac{α . n}{k} ,$$

where α is the coefficient equal to the number of porous volumes of moisture that shall be removed from the cleaned area, n—porosity of the ground, k—specific electro-osmotic transfer in the zone concerned (the amount of moisture transferred by charge 1A-sec.).

One or several electrodes may be installed inclined to the surface level, one or several electrodes may be installed horizontally near the surface, and electro-insulation coating may be laid onto the ground surface.

The mass of the anode electrode installed in each zone is determined from the condition: M₃≦2Q₃. γ where M₃ the mass of the electrode installed in the relevant zone, Q₃—the electric charge that shall be passed through the zone concerned to ensure the required degree of cleaning, γ—electro-chemical equivalent of the material from which the electrode is made. kg/A-hr.

The Applicant did not find any sources that contain the information on similar technical solutions, which allows, in the Applicant's opinion, to make a conclusion that the invention meets the “Novelty” criterion (N).

Implementation of distinguishing features of this invention stipulates an important new feature of the method—the possibility to consume as much electric power for cleaning each zone of the cleaned area to the required level as it is necessary to reach this level in the specific zone.

The Applicant did not find any information on the influence of the distinguishing features of the invention on the technical result obtained. This allows to make a conclusion that the technical solution applied conforms to the “Invention standard” criterion (IS).

### BRIEF DESCRIPTION OF DRAWINGS

The invention is explained by detailed description of an example of its implementation with references to drawings:

FIG. 1—the diagram that explains the implementation of the method—longitudinal section;

FIG. 2—arrangement of electrodes (plan);

FIG. 3,4—diagrams explaining implementation of the method as in claim 3 of the formula of invention;

FIGS. 5,6—diagrams explaining implementation of the method as in claims 4,5 of the formula of invention.

### BEST VARIANT OF IMPLEMENTATION OF THE INVENTION

The applied method is implemented as follows.

Inhomogeneity of ground is characterized by its types and parameters that influence considerably on the electro-kinetic cleaning. Among other factors are moisture content of ground, specific electric resistance of ground, cation exchange capacity, specific electro-osmotic transfer. Practically any polluted area contains 2 or several layers of non-homogeneous ground (e.g. sand, clay). Even if only one type of ground is available (e.g. sand) the level of ground waters divides the cleaned area into zones with high or low water content, which differ considerably by their electric and electro-kinetic parameters. Inhomogeneity of the area is also characterized by presence of pollutants of different kinds and spatial inhomogeneity of their concentrations. The summarized charge to be passed through the polluted zone in the same type of ground depends to a large extent on the concentration of the pollutant. Therefore the area of cleaning can be divided into zones the boundaries of which are determined by the excess of the concentration of the pollutant over the normal value by a certain number of times.

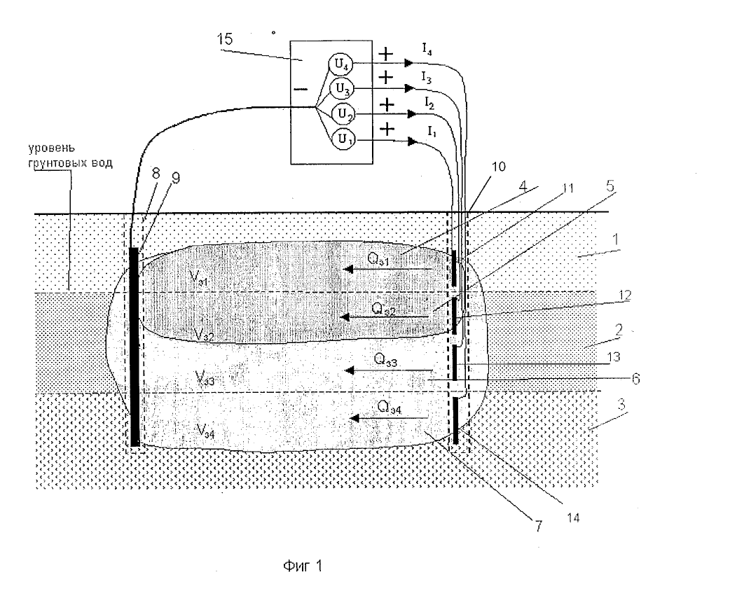

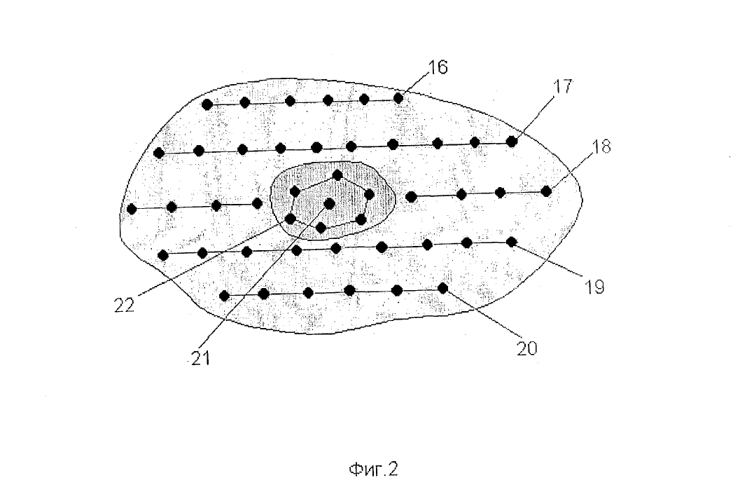

The area of ground shown in FIG. 1 consists of the upper layer which is non-saturated sand, 2—sand with high moisture content and 3—the bottom layer composed of clay with high moisture content. The polluted ground is divided additionally into zones by concentration and/or type of the pollutant. In the specific example zones 4 and 5 are polluted with benzene with concentration 3 g/kg and zones 6 and 7 polluted with diesel fuel with concentration 2 g/kg Thus the cleaned area is divided into four zones:

Non-saturated sand polluted with benzene;

Sand with high moisture content polluted with benzene;

Sand with high moisture content polluted with diesel fuel;

Clay with high moisture content polluted with diesel fuel.

Volumes V₃, of ground to he cleaned are determined in each of the four zones: V₃₁, V₃₂, V₃₃, V₃₄. Next electric charges Q₃ to be conducted through each zone to ensure the required degree of cleaning are determined: Q₃₁, Q₃₂, Q₃₃, Q₃₄ . For this purpose specific charges q₃ required to clean a unit of ground volume in each zone: q₃₁, q₃₂, q₃₃, q₃₄ are determined by conducting laboratory tests of ground specimens in each zone or on the basis of available experimental and reference data. The value of q₃ is within the range 200≦q≦2000 A-hr/m³. Then borehole 8 is drilled within the boundaries of the area to be cleaned in which (regarding the specific example) one general cathode 9 is installed; in borehole 10 the following equipment is installed: in zone 4—anode 11, in zone 5—anode 12, in zone 6—anode 13, in zone 7—anode 14. Next voltage is supplied from DC source 15 (in the specific example—a multi-channel rectifier) to cathode 9 and anodes 11,12,13,14 (U₁, U₂,U₃, U₄ respectively) These voltages are calculated so as to maintain electric intensity E≧0.05 V/cm in each point of the cleaned area (in all the four zones). Then the value of electric charges Q₃ that pass actually through each zone within a certain period of time t is monitored: Q₃₁—in zone 4, Q₃₂—in zone 5, Q₃₃—in zone 6, Q₃₄—in zone 7.

Q₃ is all integral variable:

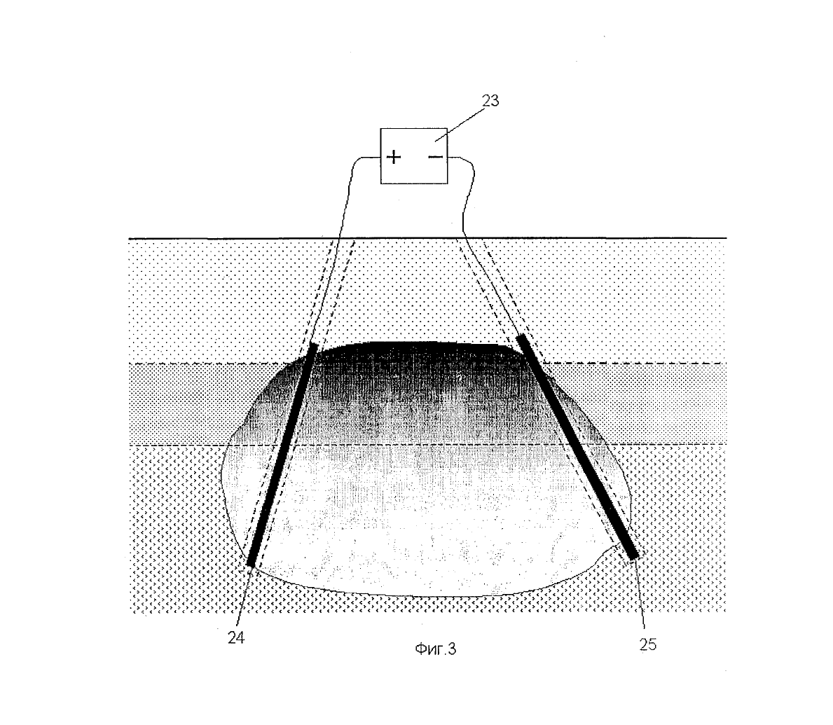

Q₃=ƒ₀′I(t) d, where 1(t) is the current that passes through the cleaned zone during time period t. When Q₃ reaches its calculated value Q₃ in each zone the current flow in the specific zone is stopped. The process of cleaning in this zone is completed and in other zones it is continued until Q₃ becomes equal to Q₃ in each cleaned zone. Thus only Such amount of electric power is consumed for cleaning each zone, which is necessary to reach the required result taking into account the character of ground, type and concentration of the pollutant. In FIG. 1, which illustrates the example one cathode and several anodes are provided; actually depending on the size of the area to be cleaned several cathodes and a great number of anodes are used as it is shown in FIG. 2 In the event that the cleaned area is polluted uniformly, anodes 16,18,20 and cathodes 17,19 are arranged in rows parallel to straight lines. If a locally polluted area is present (the so called “hot spot”) which differs from other area by a higher concentration of the pollutant, cathode 21 is arranged in the middle of the spot and anodes 22—over its periphery. As a rule electrodes are spaced at 0.5-2 m both in the rows and between the rows.

When cleaning fine porous ground, particularly loams, silts, clays etc the value of specific charge q₃ can be calculated more accurately from equation:

$${q}_{3} = \frac{α . n}{k} ,$$

where α is a coefficient equal to the number of porous volumes of moisture that shall be removed out of the cleaned area, n—porosity of ground, k—specific electro-osmotic transfer in the specific zone (the amount of moisture transferred by a charge of 1A-sec).

The value of coefficient α is determined by laboratory tests of the ground specimen and is within the range of 0.5≦α≦10.

Porosity of ground “n” is a standard geological characteristic.

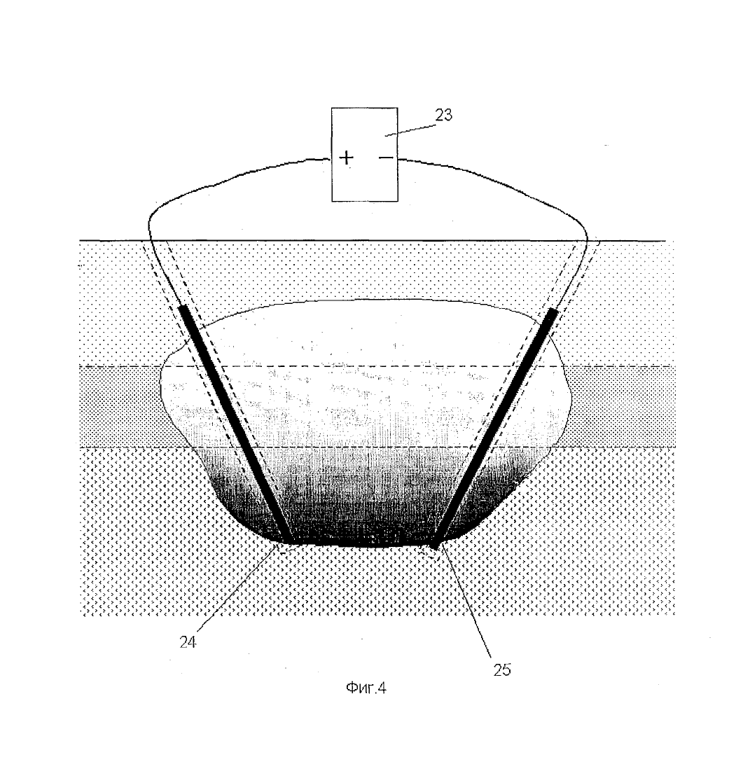

To provide various values of electric intensity in different zones of the cleaned area DC source 23 with a single-channel rectifier may be used instead of supply of various voltages into each zone from a DC source with a multi-channel rectifier; in this case one or several electrodes shall be installed inclined to the ground surface. In the example shown in FIG. 3 anode 24 and cathode 25 are inclined to each other, in this case concentration of the pollutant decreases from top to bottom and accordingly electric intensity decreases in the same direction.

In the example shown in FIG. 4 concentration of the pollutant and accordingly, electric intensity increase from top to bottom.

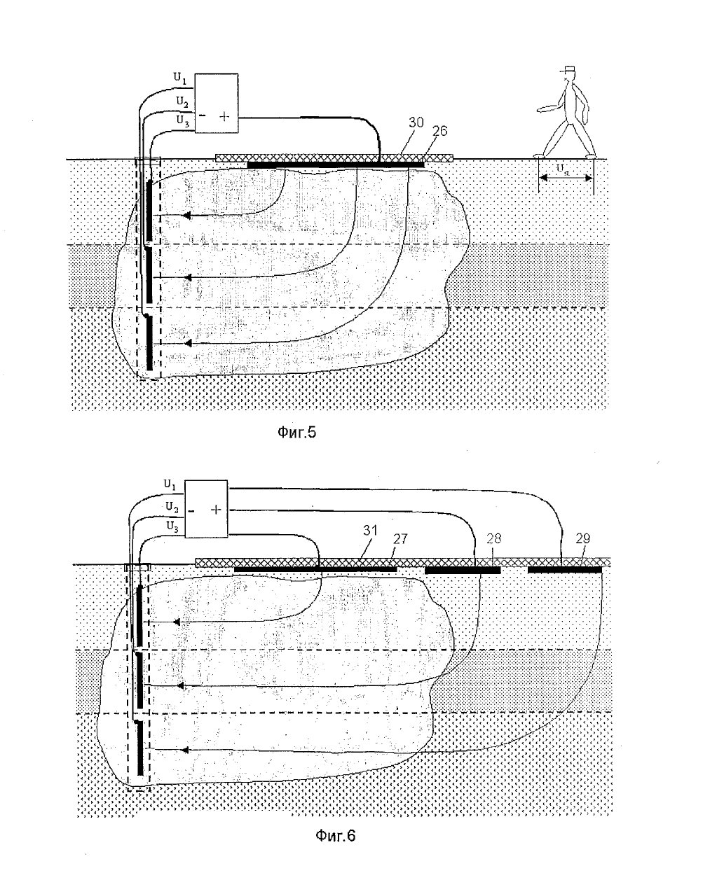

Depending on the character and localization of the pollutant one anode 26 (FIG. 5) or several anodes 28,29,30 can be installed horizontally near the ground surface, in some cases it allows to reduce the volume of drilling work.

To increase electric safety electric coating 30 (FIG. 5) or 31 (FIG. 6) is laid onto the ground surface when anodes are in horizontal position. In this case step voltage on the ground surface is determined by calculation and then measured in the process of cleaning that ground. Permissible step voltage restricts the value of voltage between electrodes and is determined by the formula:

U_{St}≦5 +0.03ρ,

Where U_{St}—step voltage, V; ρ—specific electric resistance of the surface layer or coating, (concrete, asphalt) of ground, Ohm-m.

The specific electric resistance of the coating is determined from the equation:

$$ρ > \frac{{U}_{st} - 5}{0.03}$$

where ρ—specific electric resistance of the coating, Ohm-m.

U_{St}—permissible value of step voltage, V.

The number of anodes and cathodes and their position do not compulsorily remain constant during, the whole period of cleaning. Electrodes can change their polarity (for reversing the direction of electro-kinetic flows) and the ratio of anode and cathode densities of current can also change (row diagrams can be converted to cluster ones and vice versa).

When carrying, out electro-kinetic cleaning, anodes shall be designed in such a way as to maintain their efficiency over the whole period of cleaning of the pollution area. For this purpose the condition of reserving not less than half of the anodes mass after electro-chemical solution:

M≧2Q₃γ,

Where γ—electro-chemical equivalent of the material, from which anode electrodes are made.

Q₃—full charge to be passed through the zone of cleaning to ensure the necessary degree of cleaning.

Electrodes can be arranged beyond the cleaning area, on its boundary or inside the area. When electrodes are installed inside the cleaning, area the extreme electrodes shall be arranged at a distance not exceeding half of the electrode-to-electrode distance from the boundary of the area.

A pollutant is transferred from the off-electrode space due to diffusion and arising during the electro-osmotic transfer of mechanical forces.

Field tests of the method were conducted in homogeneous ground (sand loam) with undisturbed structure on a spot locally polluted with petroleum products. The spot (3 m²) was located under the soil layer at a depth of 0.5 to 3 m. Due to vertical inhomogeneity of pollution the spot was divided into 2 areas 1 m and 2.5 m thick with average concentration of pollutants 650 mg/kg and 2950 mg/kg respectively. Taking into account local character of pollution, an arrangement of electrodes with a sectional central electrode was selected. For parameters and modes of processing of the spot see the table.

### INDUSTRIAL APPLICABILITY

The method is implemented with application of usual equipment, which allows to make a conclusion that the invention conforms to the “Industrial applicability” (1A) criterion.

Parameters and modes of processing of the area of polluted non-homogeneous ground

TABLE

| | Upper area of polluted | Lower area of polluted |
|---|---|---|
| Area processed | ground | ground |
| Volume of ground, m³ | 3 | 4.7 |
| Replaced porous | 0.5 | 1 |
| volume, α | | |
| Porosity, n | 0.4 | 0.4 |
| Specific electro-osmotic | 0.2 | 0.2 |
| transfer, m³/A-hr | | |
| Specific charge, A- | 280 | 560 |
| hr/m³ | | |
| Full charge to ensure | 840 | 2600 |
| cleaning, A-hr | | |
| Min. electric intensity, | 0.1 | 0.15 |
| V/m | | |
| DC voltage, V | 50 | 75 |
| Initial specific electric | 100 | 100 |
| resistance of ground, | | |
| Ohm-m | | |
| Averaie current, A | 0.94 | 2 |
| Initial concentration of | 650 | 2950 |
| pollutant, mg/kg | | |
| Final concentration of | 25 | 40 |
| pollutant, mg/kg | | |
| Time of cleaning, days | 37 | 54 |

1. Method of cleaning the area of polluted non-homogeneous ground installation of anode and cathode electrodes in the ground, division of the area of polluted non-homogeneous ground into zones by characteristics of ground and conducting appropriate DC voltage into each zone is characterized that the area of polluted ground is divided additionally into zones by concentration and/or type of pollutant, volume V₃ of ground to be cleaned in each zone is determined, electric charge Q₃ to be passed through each zone to provide the required degree of cleaning is calculated from equation Q₃=q₃ V₃ where q₃—specific charge required for cleaning a unit of ground volume in the zone concerned, electric intensity E≧0.05 V/cm is maintained in each point of the cleaned area, the value of electric charge Q₃, that actually passes through each zone during period t counting from the start of cleaning is monitored, the value of Q₃ being calculated by the formula: Q₃=∫₀′I(t)d. where 1(t)—the amount of electric current that passes through the cleaned zone and when Q₃ becomes equal to Q₃ the conducting of electric current through the relevant zone is stopped.

2. The method as in p. 1 is characterized that during cleaning fine porous grounds value q₃ is found from equation:
$${q}_{3} = \frac{α . n}{k .}$$
where α is a coefficient equal to the number of porous volumes of moisture that shall be removed out of the cleaned area, n—porosity of ground k—specific electro-osmotic transfer in the specific zone (the amount of moisture transferred by a charge of 1A-sec).

3. Method as in pp. 1 or 2 is characterized that one or several electrodes are installed inclined to the ground surface.

4. Method as in any of pp. 1-3 is characterized that one or several anode electrodes are installed inclined near the ground surface.

5. Method as in pp. 4 is characterized that an electric insulation coating is laid onto the ground surface.

6. Method as in any of pp. 1-5 is characterized that the mass of the anode electrode installed in each zone is determined from condition M₃≧2Q₃γ, where M₃—mass of the electrode installed in the specific zone, Q₃—electric charge that to be passed through the specific zone to ensure the necessary degree of cleaning, γ—electro-chemical equivalent of the material, from which anode electrodes are made, kg,/A-hr.
